(19) United States
(12) Patent Application Publication
(10) Pub. No.: US 2018/0253025 A1
(43) Pub. Date: Sep. 6, 2018

(54) PRINT HEAD AND IMAGE FORMING APPARATUS

(71) Applicants: KABUSHIKI KAISHA TOSHIBA, Tokyo (JP); TOSHIBA TEC KABUSHIKI KAISHA, Tokyo (JP)

(72) Inventor: Koji Tanimoto, Tagata Kanagawa (JP)

(21) Appl. No.: 15/447,233

(22) Filed: Mar. 2, 2017

(51) Int. Cl. B41J 2/385

(52) U.S. Cl. CPC G03G 15/04054; G03G 2215/0409; G03G 15/0409; G03G 15/0435

(57) ABSTRACT

According to one embodiment, there is provided a print head including a transparent substrate, light-emitting elements, a lens, and a member. The transparent substrate includes a first surface and a second surface. The light-emitting elements are on the first surface of the transparent substrate. The lens condenses the irradiation light from the light-emitting elements that is transmitted through the first surface and the second surface, onto an object. The member is a member for preventing a part of reflected light of the irradiation light from being incident again on the incident surface of the lens.

### FIELD

Embodiments described herein relate generally to a print head, an image forming apparatus, and method associated therewith.

### BACKGROUND

Printers, copiers, and multifunction machines (MFP: Multi-Functional Peripheral) using an electrophotographic process are known. Two systems called a laser optical system (LSU: laser scan unit) and a print head (solid head) are known as an exposure unit of these devices. In the laser optical system, a photoreceptor drum is exposed by laser beam scanned by a polygon mirror. In the print head, the photoreceptor drum is exposed by light emitted from a plurality of light-emitting elements such as a light emitting diode (LED).

Since the laser optical system needs to rotate a polygon mirror at a high speed, the system consumes a lot of energy when forming an image and makes an operation sound. Further, since a mechanism for scanning a laser beam is required, there is a tendency that the system has a large unit shape.

On the one hand, the print head may be configured in a compact exposure unit. A compact exposure unit is realized by using a lens called a rod lens array through which the light emitted from light-emitting elements is transmitted to form an erect image. In addition, since there is no moving part, it is quiet during operation.

Besides the print head using an LED, a print head using an organic light emitting diode (organic EL) has also been developed. An organic EL may be formed on a substrate collectively using a mask, and the light-emitting elements may be arranged more accurately than arranging the LEDs. Therefore, when an organic EL is used as a light-emitting element, there is an advantage that image formation with high precision is possible.

For example, an example in which a plurality of light-emitting elements made of an organic EL are formed on a glass substrate is known.

An example of related art includes JP-A-2005-96211.

### DESCRIPTION OF THE DRAWINGS

FIG. 1 is a diagram showing an example of a positional relationship between a photoreceptor drum and a print head according to an embodiment.

FIG. 2 is a diagram showing an example of a transparent substrate constituting a print head according to the embodiment.

FIG. 3 is a diagram showing an example of light-emitting elements according to the embodiment.

FIG. 4 is a diagram showing a first example of the print head.

FIG. 5 is a diagram showing a second example of the print head.

FIG. 6A is a diagram showing a third example of the print head.

FIG. 6B is a diagram showing an example of positioning the transparent substrate in the print head shown in FIG. 6A.

FIG. 7 is a diagram showing a comparative example of the print head of the embodiment.

FIG. 8 is a diagram showing an example of a ghost-like image.

FIG. 9 is a diagram showing an example of an image which does not include the ghost-like image.

FIG. 10 is a diagram showing an example of an image forming apparatus to which the print head of the embodiment is applied.

### DETAILED DESCRIPTION

For example, when the organic EL of the print head is caused to emit light, the light from the organic EL is incident on the lens, and the photoreceptor charged with the light from the lens is exposed. However, the light from the organic EL is reflected on the lens surface. This reflected light is further reflected on a transparent substrate (glass substrate) and may be incident on the lens again. This may affect the quality of image formation.

In general, according to one embodiment, there are provided a print head and an image forming apparatus for preventing light from being incident on a lens again.

A print head of an embodiment includes a transparent substrate, a light-emitting element, a lens, and a member. The transparent substrate includes a first surface and a second surface. The light-emitting elements are on the first surface of the transparent substrate. The lens condenses the irradiation light from the light-emitting elements that is transmitted through the first surface and the second surface, onto an object. The member is a member for preventing a part of reflected light of the irradiation light from being incident again on an incident surface of the lens.

Hereinafter, an embodiment will be described with reference to the drawings.

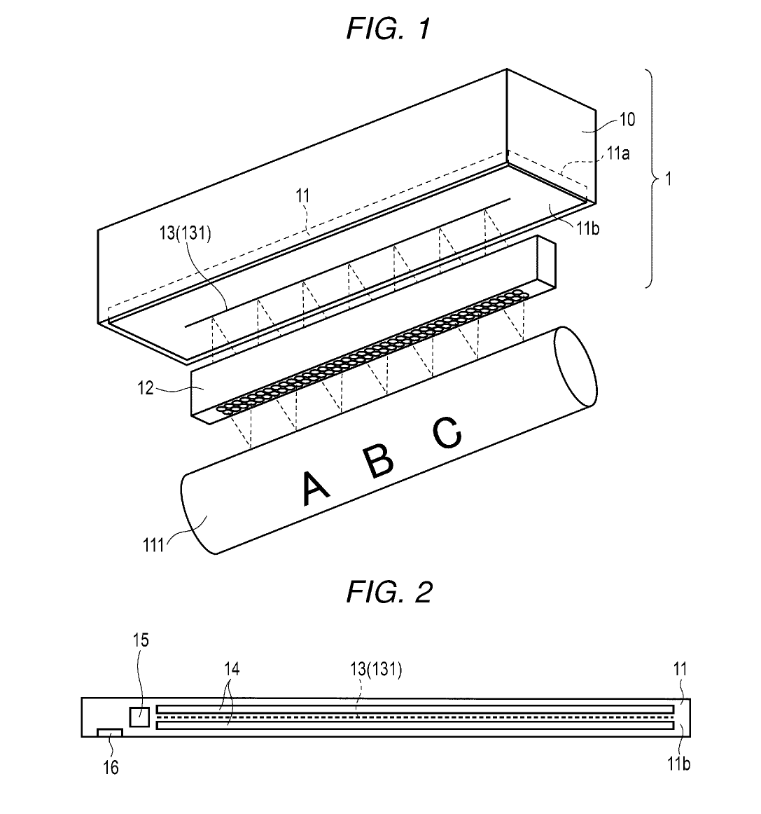

FIG. 1 is a diagram showing an example of a positional relationship between a photoreceptor drum and a print head used in the electrophotographic process according to an embodiment. For example, an image forming apparatus such as a printer, a copier, a multifunction machine or the like is equipped with a photoreceptor drum 111 shown in FIG. 1 and a print head 1 may be mounted on the image forming apparatus.

As shown in FIG. 1, a print head 1 includes a housing 10, a transparent substrate 11, and a rod lens array 12. For example, the transparent substrate 11 is a glass substrate which transmits light and has a first surface (first plane) 11a and a second surface (second plane) 11b. On the first surface 11a of the transparent substrate 11, there are a plurality of light-emitting elements 131, and a light-emitting element array 13 corresponding to the plurality of light-emitting elements 131 is formed. Light from the plurality of light-emitting elements 131 is incident on an incident surface (lens surface) of the rod lens array 12, passes through the rod lens array 12, and is focused on the photoreceptor drum 111. The light-emitting element array 13 is constituted by a plurality of light-emitting elements 131.

The photoreceptor drum 111 is uniformly charged by a charger and is exposed by light from a plurality of light-emitting elements 131, whereby a potential thereof is lowered. That is, by controlling light emission and non-light emission of the plurality of light-emitting elements 131, it is possible to form an electrostatic latent image on the photoreceptor drum 111.

FIG. 2 is a diagram showing an example of a transparent substrate constituting a print head according to the embodiment.

As shown in FIG. 2, the light-emitting element array 13 is formed along the longitudinal direction of the transparent substrate 11 in the central part on the transparent substrate 11. In the vicinity of the light-emitting element array 13, a DRV circuit array 14 for driving the light-emitting elements 131 (to emit light) is formed.

In FIG. 2, an example in which the DRV circuit array 14 is disposed at both sides of the light-emitting element array 13 as the center is shown. However, the DRV circuit array 14 may be arranged in one side.

Further, the transparent substrate 11 includes an integrated circuit (IC) 15. The IC 15 includes a digital to analog (D/A) conversion circuit, a selector, an address counter and the like. The D/A conversion circuit, the selector, and the address counter supply a signal for controlling the emission intensity and on/off of each light-emitting element to the DRV circuit. In addition, the transparent substrate 11 includes a connector 16. The connector 16 electrically connects the print head 1 with a printer, a copier, or a multifunction machine.

For example, a substrate for sealing each light-emitting element, a DRV circuit, and the like is attached to the transparent substrate 11 such that each light-emitting element, the DRV circuit, and the like are not contacted by outside air.

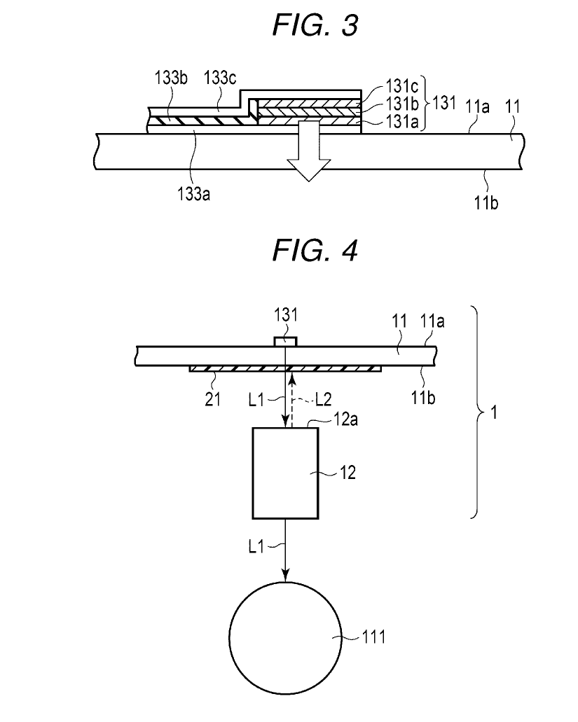

FIG. 3 is a diagram showing an example of light-emitting elements according to the embodiment. In FIG. 3, a substrate for sealing is omitted.

A plurality of the light-emitting elements 131 are formed on the transparent substrate 11. The light-emitting elements 131 are in contact with an electrode (+) 133a and an electrode (−) 133c insulated by an insulating layer 133b, and sandwiched therebetween. The light-emitting elements 131 include a hole transport layer 131a, a light-emitting layer 131b, and an electron transport layer 131c. For example, the light-emitting layer 131b is an organic EL.

Hereinafter, with reference to FIGS. 4, 5, 6A, and 6B, a configuration for preventing degradation of the image quality due to the reflected light or the like generated in the print head 1 described in FIGS. 1, 2, and 3 will be described.

FIG. 4 is a diagram showing a first example of the print head. As shown in FIG. 4, the print head 1 includes the transparent substrate 11, an anti-reflection member 21 (anti-reflection film), the light-emitting elements 131, and the rod lens array 12. The transparent substrate 11 includes the first surface 11a and the second surface 11b.

The light-emitting elements 131 are on the first surface 11a of the transparent substrate 11. Light L1 emitted from the light-emitting elements 131 is sequentially transmitted through the first surface 11a, the second surface 11b, and the anti-reflection member 21, and is incident on an incident surface 12a of the rod lens array 12. The rod lens array 12 condenses the light L1 from the incident surface 12a onto the photoreceptor drum 111.

The anti-reflection member 21 is a member for preventing a part of reflected light of the light L1 from being incident again on the incident surface 12a of the rod lens array 12. That is, the anti-reflection member 21 prevents reflected light L2 from being incident again on the rod lens array 12. As shown in FIG. 4, the anti-reflection member 21 is on the second surface 11b of the transparent substrate 11. That is, the anti-reflection member 21 is on the opposite side of the first surface 11a on which the light-emitting elements 131 are disposed. For example, it is preferable that the anti-reflection member 21 is suitable for a light wavelength output by the light-emitting elements 131, that is, it is preferable to employ a member having excellent anti-reflection effect. For example, for emission of red light, the anti-reflection member 21 is formed on the transparent substrate 11 with MgF2 (magnesium fluoride) or the like. Alternatively, anti-reflection film may be attached to the transparent substrate 11.

The light L1 output from the light-emitting elements 131 passes through the transparent substrate 11 and the anti-reflection member 21, and is condensed by the rod lens array 12 to expose the photoreceptor drum 111. A part of the light L1 that has passed through the transparent substrate 11 and the anti-reflection member 21 is reflected on the incident surface 12a of the rod lens array 12, and the reflected light L2 returns to the anti-reflection member 21. The anti-reflection member 21 provided on the second surface 11b of the transparent substrate 11 suppresses the reflected light L2. In other words, the anti-reflection member 21 prevents further reflection of the reflected light L2. In this way, it is prevented that the reflected light L2 returns to the rod lens array 12 side. Therefore, it is possible to prevent the unnecessary reflected light L2 from exposing the photoreceptor drum 111.

A positioning member (holder) for determining the mutual positional relationship between the transparent substrate 11, the anti-reflection member 21, and the rod lens array 12 on which the light-emitting elements 131 are formed is omitted from the drawing.

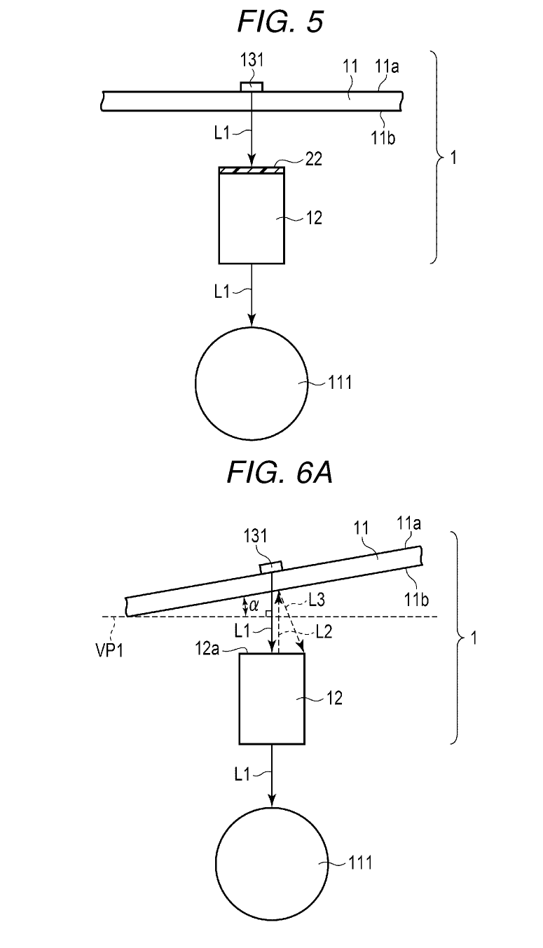

FIG. 5 is a diagram showing a second example of the print head. As shown in FIG. 5, the print head 1 includes the transparent substrate 11, an anti-reflection member (anti-reflection film) 22, the light-emitting elements 131, and the rod lens array 12. As shown in FIG. 5, the anti-reflection member 22 is on the lens surface (on the incident surface) of the rod lens array 12. The anti-reflection member 22 may be attached to the lens surface of the rod lens array 12. The anti-reflection member 22 is a member for preventing reflected light from being generated on the lens surface of the rod lens array 12.

The light L1 output from the light-emitting elements 131 is transmitted through the transparent substrate 11, further passes through the anti-reflection member 22, is condensed by the rod lens array 12, and then exposes the photoreceptor drum 111. No reflection light is generated on the lens surface by the anti-reflection member 22. Therefore, it is possible to prevent the unnecessary reflected light from exposing the photoreceptor drum 111.

A positioning member (holder) for determining the mutual positional relationship between the transparent substrate 11, the anti-reflection member 22, and the rod lens array 12 on which the light-emitting elements 131 are formed is omitted from the drawing.

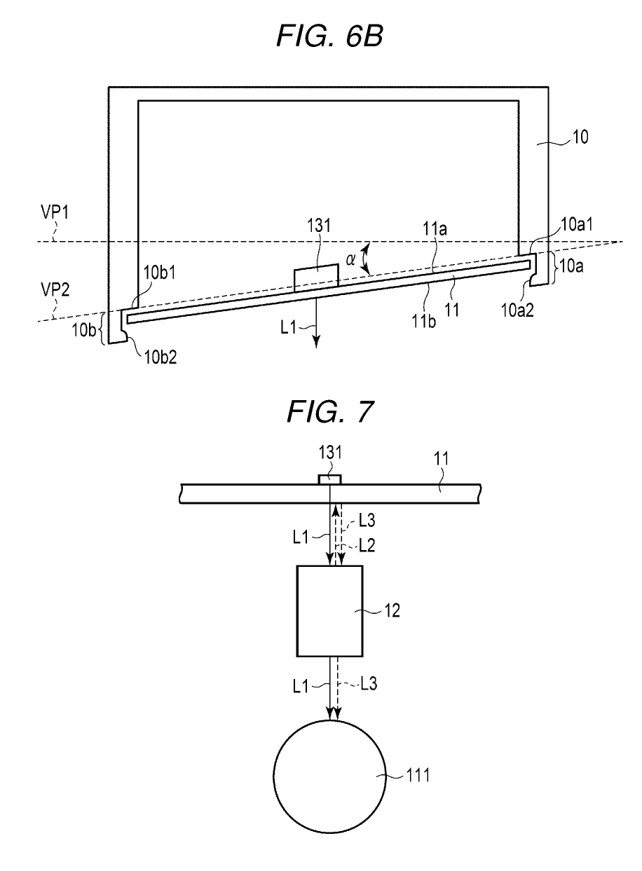

FIG. 6A is a diagram showing a third example of the print head. As shown in FIGS. 6A and 6B, the print head 1 includes the transparent substrate 11, the light-emitting elements 131, and the rod lens array 12. The transparent substrate 11 includes the first surface 11a and the second surface 11b.

The second surface 11b of the transparent substrate 11 has a predetermined angle α with respect to a virtual plane VP1 orthogonal to the optical axis of the rod lens array 12. That is, according to the positioning of the transparent substrate 11, the optical axis of the lens is not in the vertical direction with respect to the plane of the transparent substrate 11. In one embodiment, the predetermined angle α is an acute angle. In another embodiment, the predetermined angle α is less than 45 degrees. In yet another embodiment, the predetermined angle α is less than 30 degrees.

The light L1 output from the light-emitting elements 131 passes through the transparent substrate 11 and is condensed by the rod lens array 12 to expose the photoreceptor drum 111. A part of the light L1 that has passed through the transparent substrate 11 is reflected on the surface of the rod lens array 12, and the reflected light L2 returns to the second surface 11b of the transparent substrate 11. Here, since the transparent substrate 11 (second surface 11b) is not vertical with respect to the optical axis direction of the rod lens array 12, reflected light L3 on the transparent substrate 11 (second surface 11b) does not return to the rod lens array 12 or most of the reflected light L3 does not return to the rod lens array 12. Therefore, it is possible to prevent the unnecessary reflected light L3 from exposing the photoreceptor drum 111. Alternatively, it is possible to suppress the unnecessary reflected light L3 from exposing the photoreceptor drum 111.

FIG. 6B is a diagram showing an example of positioning the transparent substrate in the print head shown in FIG. 6A. As shown in FIG. 6B, the print head 1 includes the housing 10 and the transparent substrate 11, and a transparent substrate 11 is attached to the housing 10.

The housing 10 includes a holding portion 10a for holding one end of the transparent substrate 11 and a holding portion 10b for holding the other end of the transparent substrate 11. The holding portion 10a includes a support portion 10a1 for supporting one end of the first surface 11a of the transparent substrate 11. The holding portion 10b includes a support portion 10b1 for supporting the other end of the first surface 11a of the transparent substrate 11. The holding portion 10a includes an arc-shaped falling-off prevention portion 10a2 which holds one end of the second surface 11b of the transparent substrate 11 and prevents the transparent substrate 11 from falling off from the housing 10. The holding portion 10b includes an arc-shaped falling-off prevention portion 10b2 which holds the other end of the second surface 11b of the transparent substrate 11 and prevents the transparent substrate 11 from falling off from the housing 10. That is, the transparent substrate 11 inserted toward the housing 10 is supported by the support portions 10a1 and 10b1, and is held so as not to fall off at the falling-off prevention portions 10a2 and 10b2.

A virtual plane VP2 located on a straight line connecting the support portion 10a1 and the support portion 10b1, and the virtual plane VP1 orthogonal to the optical axis have a predetermined angle α. In this way, simply attaching the transparent substrate 11 toward the housing 10 completes positioning of the transparent substrate 11. That is, the transparent substrate 11 is attached to the virtual plane VP1 at the predetermined angle α.

Here, a print head as shown in FIG. 7, that is, a print head in which the surface of the transparent substrate 11 is orthogonal to the optical axis is considered. In the case of such a print head, the light L1 emitted from the light-emitting elements 131 is reflected on the lens surface of the rod lens array 12, the reflected light L2 is reflected again on the transparent substrate 11, and the reflected light L3 is incident on the rod lens array 12. Therefore, the photoreceptor drum is exposed to the light L1 and the reflected light L3 irradiated from the light-emitting elements 131.

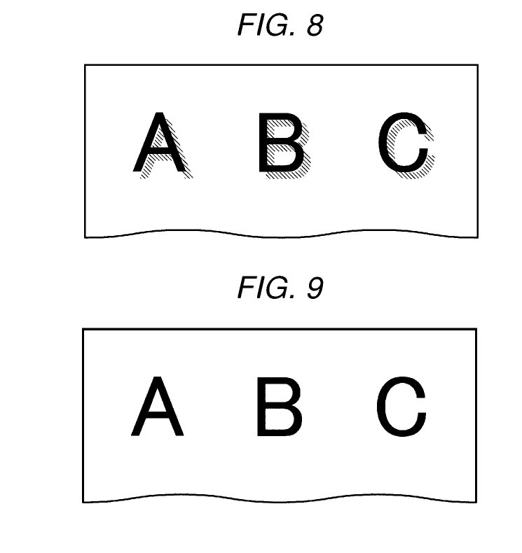

As a result, an image as shown in FIG. 8 is formed. As shown in FIG. 8, an image with a predetermined density to be originally formed and a ghost-like image with a low density are formed.

The print head 1 shown in FIGS. 4, 5, 6A, and 6B may prevent the unnecessary reflected light L3 from exposing the photoreceptor drum 111. Alternatively, it is possible to suppress the unnecessary reflected light L3 from exposing the photoreceptor drum 111. Therefore, it is possible to form an image with a predetermined density which does not include a ghost-like image as shown in FIG. 9.

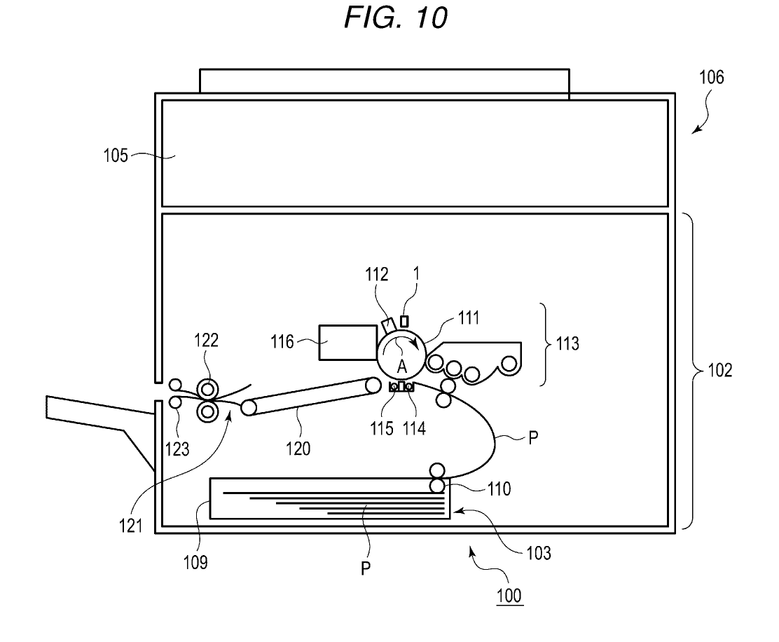

FIG. 10 is a diagram showing an example of an image forming apparatus to which the print head 1 of the present embodiment is applied. In FIG. 10, an example of a monochrome image forming apparatus is shown, but the print head 1 of this present embodiment may also be applied to a color image forming apparatus.

An image forming apparatus 100 includes an image forming unit 102 and a scanner 105. A mechanism of the image forming unit 102 will be described. The image forming unit 102 includes an electrostatic charger 112, a developer 113, a transfer charger 114, a separation charger 115, and a cleaner 116 in the vicinity of the photoreceptor drum 111. The electrostatic charger 112 uniformly charges the photoreceptor drum 111. The developer 113 develops a latent image created based on the image data from the scanner 105 on the charged photoreceptor drum 111. The transfer charger 114 transfers the image developed on the photoreceptor drum 111 to a paper P. The cleaner 116 cleans the developing agent that currently remains in the photoreceptor drum 111.

The electrostatic charger 112, the developer 113, the transfer charger 114, the separation charger 115, and the cleaner 116 are sequentially disposed according to the rotation direction of an arrow A of the photoreceptor drum 111. Further, the image forming unit 102 includes the print head 1 disposed opposite to the photoreceptor drum 111.

The image forming unit 102 includes a carrying belt 120 and a paper discharge guide 121. The carrying belt 120 and the paper discharge guide 121 convey the paper P onto which a toner image has been transferred sequentially from the separation charger 115 downstream in the paper conveyance direction. Further, the image forming unit 102 includes a fixing device 122 and a paper discharge roller 123. The fixing device 122 sequentially fixes the paper P to the downstream side in the paper conveyance direction from the paper discharge guide 121, and the paper discharge roller 123 discharges the paper P.

Next, a process operation of image forming will be described.

The electrostatic latent image formed on the photoreceptor drum 111 by the light L1 from the print head 1 (light-emitting elements 131) is developed by the toner (developing agent) supplied from the developer 113. The photoreceptor drum 111 on which the toner image is formed transfers the electrostatic latent image onto the paper P by the transfer charger 114.

The remaining toner on the surface of the photoreceptor drum 111 that has finished transfer to the paper is removed by the cleaner 116, and the process operation returns to an initial state and enters a standby state for the next image formation.

By repeating the above process operation, an image forming operation is continuously performed.

Note that, the print head 1 of the present embodiment is not limited to a print head in the electrophotographic process, but may also be used as units for exposing film or the like.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A print head comprising:
a transparent substrate having a first surface and a second surface;
light-emitting elements on the first surface of the transparent substrate;
a lens for condensing the irradiation light from the light-emitting elements transmitted through the first surface and the second surface onto an object; and
a member for preventing a part of reflected light of the irradiation light from being incident again on an incident surface of the lens, wherein the member is an anti-reflection member suitable for a light wavelength output by the light-emitting elements.

2. The print head according to claim 1,
wherein the anti-reflection member prevents further reflection of the reflected light.

3. The print head according to claim 2,
wherein the member is on the second surface.

4. The print head according to claim 1,
wherein the anti-reflection member prevents generation of the reflected light.

5. The print head according to claim 4,
wherein the member is on the incident surface of the lens.

6. The print head according to claim 1,
wherein the light-emitting elements are an organic EL.

7. (canceled)

8. (canceled)

9. (canceled)

10. (canceled)

11. An image forming apparatus comprising:
a photoreceptor;
a charger for charging the photoreceptor;
a print head exposing the charged photoreceptor; and
a developer for developing a latent image on the photoreceptor,
wherein the print head comprises:
a transparent substrate having a first surface and a second surface;
light-emitting elements on the first surface of the transparent substrate;
a lens for condensing irradiation light from the light-emitting elements transmitted through the first surface and the second surface onto an object; and
a member for preventing a part of reflected light of the irradiation light from being incident again on an incident surface of the lens, wherein the member is an anti-reflection member suitable for a light wavelength output by the light-emitting elements.

12. The image forming apparatus according to claim 11,
wherein the anti-reflection member prevents further reflection of the reflected light.

13. The image forming apparatus according to claim 11,
wherein the anti-reflection member prevents generation of the reflected light.

14. The image forming apparatus according to claim 11,
wherein the light-emitting elements are an organic EL.

15. (canceled)

16. (canceled)

17. (canceled)

18. (canceled)

19. (canceled)

20. (canceled)

21. The print head of claim 1, wherein the light-emitting elements emit red light and the anti-reflection member includes magnesium fluoride (MgF2).
